(19) United States
(12) Patent Application Publication
(10) Pub. No.: US 2021/0289975 A1
(43) Pub. Date: Sep. 23, 2021

(54) Steaming Device

(71) Applicant: Advanced Technologies for Tomorrow Today, LLC (ATfTT), Morgantown, WV (US)

(72) Inventor: James Earl Smith, Bruceton Mill, WV (US)

(21) Appl. No.: 17/203,252

(22) Filed: Mar. 16, 2021

Related U.S. Application Data
(60) Provisional application No. 62/990,774, filed on Mar. 17, 2020.

(51) Int. Cl. A47J 27/04; A47J 36/20

(52) U.S. Cl. CPC A47J 27/04; A47J 45/071; A47J 2027/043; A47J 36/20

(57) ABSTRACT

A steaming device includes a first chamber, a second chamber, and a block formed from a porous ceramic material. The first chamber comprises a surface and sidewalls extending from the surface. The second chamber comprises a cooking surface and sidewalls extending from the cooking surface and is configured to receive a foodstuff. The cooking surface defines a plurality of openings. The block is disposed between the surface of the first chamber and the cooking surface of the second chamber. The block is configured to absorb and retain water when the water is in a liquid state and to release the water as steam when heated. The steam passes into the second chamber via the plurality of openings arranged in the cooking surface to distribute the steam to the second chamber to thereby steam the foodstuff.

### RELATED APPLICATIONS

This application claims the benefit of priority under 35 U.S.C. § 119(e) of U.S. Provisional Application No. 62/990,774, filed Mar. 17, 2020, the content of which is incorporated herein by reference in its entirety.

### BACKGROUND

### Field

This application generally relates to cooking equipment. In particular, this application describes a steaming device that could be utilized, for example, to cook vegetables, breads, or other foods.

### Description of Related Art

Outdoor cooking is becoming increasingly popular. One example of outdoor cooking involves cooking over an open fire or on an outdoor grill, which may occur at a campsite. For example, a grilling grate can be suspended over an open flame, and foodstuffs to be cooked can be placed on the grate. In some cases, foodstuffs can be skewered and suspended over the open fire or laid on the cooking grate of a grill.

However, foodstuffs cooked in this manner may produce inconsistent results. Moreover, this form of cooking does not allow the camper to experience the full range of culinary possibilities that are otherwise available in a standard kitchen.

### SUMMARY

In a first aspect, a steaming device includes a container, a cooking surface, and a block. The cooking surface is disposed within the container and divides the container into a lower chamber and an upper chamber. The cooking surface defines a plurality of openings. The block is formed from a porous ceramic material and is disposed within the lower chamber of the container. The block is configured to absorb and retain water when the water is in a liquid state and to release the water as steam when heated. The steam passes into the upper chamber of the container via the plurality of openings arranged in the cover to distribute the steam to the upper chamber of the container.

In a second aspect, a method for steaming a foodstuff includes saturating a block formed from a porous ceramic material with water. The block can be arranged in a container of a housing. A cooking surface can be arranged over the block. The cooking surface can define a plurality of openings. A source of heat can be applied to the container to thereby cause the block to release steam. The steam passes through the plurality of openings arranged in the cooking surface and is distributed to a foodstuff arranged on the cooking surface.

In a third aspect, a method for manufacturing a steaming device includes forming a container and a cooking surface from a material. The cooking surface defines a plurality of openings and is configured to be disposed within the container and to divide the container into a lower chamber and an upper chamber. A block is shaped from a porous ceramic material. The porous ceramic material is configured to absorb and retain water when the water is in a liquid state and to release the water in the form of steam when heated. The block is arranged within the lower chamber of the container. When the block is saturated with water and subsequently heated within the container, steam passes into the upper chamber of the container via the plurality of openings arranged in the cover and is distributed to the upper chamber of the container.

In a fourth aspect, a steaming device includes a first chamber, a second chamber, and a block formed from a porous ceramic material. The first chamber comprises a surface and sidewalls extending from the surface. The second chamber comprises a cooking surface and sidewalls extending from the cooking surface and is configured to receive a foodstuff. The cooking surface defines a plurality of openings. The block is disposed between the surface of the first chamber and the cooking surface of the second chamber. The block is configured to absorb and retain water when the water is in a liquid state and to release the water as steam when heated. The steam passes into the second chamber via the plurality of openings arranged in the cooking surface to distribute the steam to the second chamber to thereby steam the foodstuff.

In a fourth aspect, a method for steaming a foodstuff comprises saturating a block formed from a porous ceramic material with water, inserting the block within a first chamber that comprises a surface and sidewalls extending from the surface, and positioning a second chamber on the first chamber. The second chamber comprises a cooking surface and sidewalls extending from the cooking surface and is configured to receive a foodstuff. The cooking surface defines a plurality of openings. A source of heat is applied to the first chamber to thereby cause the block to release steam. The steam passes through the plurality of openings arranged in the cooking surface to distribute the steam to the second chamber.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1A illustrates a perspective view of a steaming device, in accordance with an example.

FIG. 1B illustrates a cross-sectional view of the steaming device, in accordance with an example.

FIG. 2A illustrates a perspective view of a container of the steaming device, in accordance with an example.

FIG. 2B illustrates a cross-sectional view of the container of the steaming device, in accordance with an example.

FIG. 3A illustrates a bottom perspective view of a cooking surface of the steaming device, in accordance with an example.

FIG. 3B illustrates a cross-sectional view of the cooking surface of the steaming device, in accordance with an example.

FIG. 4A illustrates the steaming device supported by a handle, in accordance with an example.

FIG. 4B illustrates a steaming device having enclosed channels arranged on a bottom surface of a container, in accordance with an example.

FIG. 5 illustrates features that can be included in the cooking surface and/or the container to facilitate releasably securing the cooking surface at a particular position within the container, in accordance with an example.

FIG. 6 illustrates operations performed in a method for steaming a foodstuff, in accordance with an example.

FIG. 7 illustrates operations performed in a method for manufacturing a steaming device, in accordance with an example.

FIG. 8A illustrates a perspective view of a steaming device, in accordance with an example.

FIG. 8B illustrates a top view of a handle of the steaming device, in accordance with an example.

FIG. 9A illustrates a cross-section of a cooking section of the steaming device, in accordance with an example.

FIG. 9B illustrates a top view of a cover of the cooking section of the steaming device, in accordance with an example.

FIG. 9C illustrates a top view of an upper chamber of the cooking section of the steaming device, in accordance with an example.

FIG. 9D illustrates a top view of a lower chamber of the cooking section of the steaming device, in accordance with an example.

FIG. 10 illustrates a cross-section of an alternative cooking section of the steaming device, in accordance with an example.

### DETAILED DESCRIPTION

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially,” or “about” that may be used herein, are meant that the recited characteristic, parameter, or value need not be achieved exactly, but that deviations or variations, including, for example, tolerances, measurement error, measurement accuracy limitations and other factors known to skill in the art, may occur in amounts that do not preclude the effect the characteristic was intended to provide.

### I. Introduction

As noted above, current methods for outdoor cooking can be somewhat limited. One cooking method that is generally unavailable when cooking in the outdoors involves the steaming of foodstuffs. Traditionally, steaming of foodstuffs involves suspending the foodstuffs over boiling water or in a steaming device designed for a traditional kitchen. While some of these devices can be used in the outdoors, their use is often problematic due to the sloshing of the water and uneasy handling of the equipment, particularly over an open fire.

Disclosed herein is a device that facilitates steaming foodstuffs over an open fire without the drawbacks noted above, and a method for using the device. Generally, the device includes a block formed from a porous ceramic material that can store water. The block can be placed into a container, and a cooking surface can be placed into the container and over the block. The foodstuff can be placed on the cooking surface, and the device can be placed over an open flame. The heat from the flame causes the water in the block to turn to steam. The steam passes through openings in the cooking surface to thereby steam the foodstuff.

An example of a foodstuff that can be steamed using the device is bread (e.g., slices, rolls, and buns). While bread can be used straight out of the package, some may prefer the bread to be steamed or toasted. In the case of somewhat older bread, which can lack moisture, the texture of the bread can be improved by steaming the bread using the disclosed device.

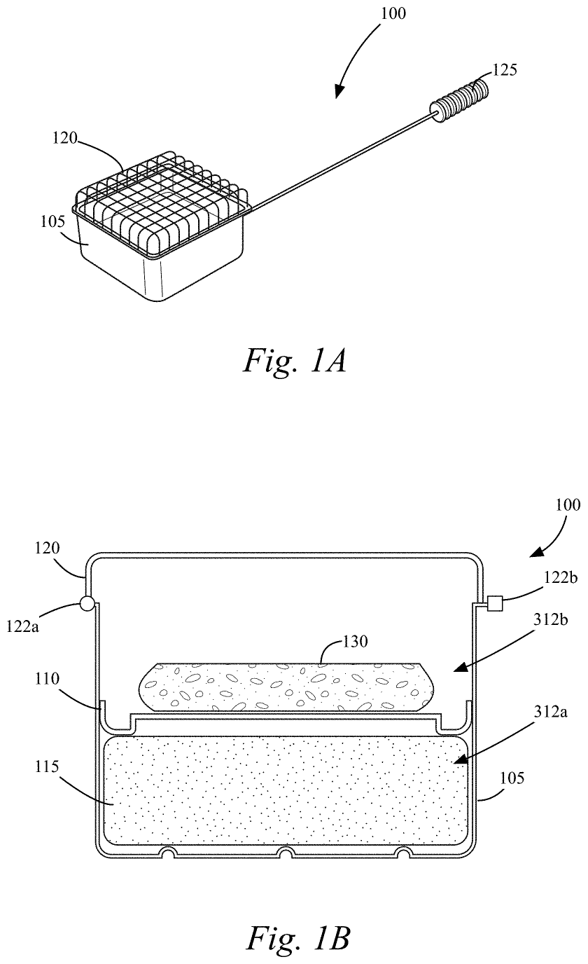

FIG. 1A illustrates a perspective view of an example of a steaming device 100.

FIG. 1B illustrates a cross-sectional view of the steaming device 100. Referring to the figures, the steaming device 100 includes a container 105, a cooking surface 110, and a block 115. An example of the steaming device 100 can also include a cover 120 and a handle 125. In an example embodiment, the steaming device 100 could be utilized outdoors, over an open fire. However, it will be understood that the steaming device 100 could be utilized in other cooking scenarios, such as over a conventional stovetop or over an electric heating surface or grill.

As described in more detail below, the cooking surface 110 is disposed within the container 105 and divides the container 105 into a lower chamber 312a and an upper chamber 312b. The cooking surface 110 defines a plurality of openings. A foodstuff 130 to be steamed can be arranged on the cooking surface 110.

The block 115 is formed from a porous ceramic material and is disposed within the lower chamber 312a of the container 105. The block 115 is configured to absorb and retain water when the water is in a liquid state and to release the water in the form of steam when heated. The steam passes into the upper chamber of the container 105 via the openings arranged in the cover 120 to distribute the steam to the upper chamber of the container 105. A foodstuff arranged within the upper chamber 312b of the container 105 can be steamed with the steam released from the block 115.

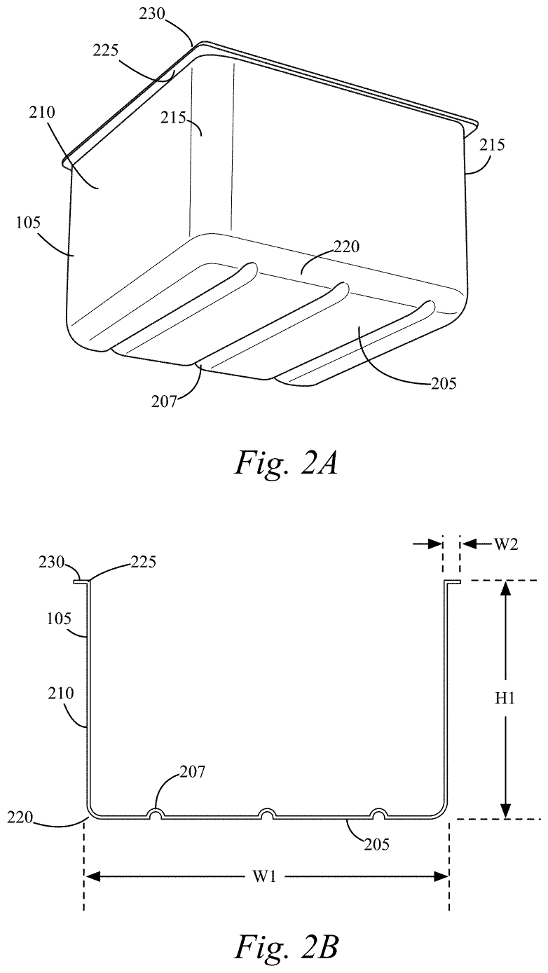

FIG. 2A illustrates a perspective view of an example of the container 105. FIG. 2B illustrates a cross-sectional view of the container 105. Referring to the figures, an example of the container 105 can have a generally cube-like shape. For example, the container 105 can include a bottom surface 205 having a generally square shape and four generally planar sidewalls 210 that extend from edges 220 of the bottom surface 205. In some examples of the container 105, the edges 215 between each of the sidewalls 210 and the edges 220 between the sidewalls 210 and the bottom surface 205 can have a radius of about ½ inch or in other examples can correspond to square edges. The bottom surface 205 can define one or more grooves 205b. As described below, the grooves 207 can be configured to received prongs of a handle.

The top edge 225 of the container 105 can define a flange 230. The flange 230 can provide a surface upon which the cover 120 can engage to secure foodstuffs 130 within the steaming device. An example of the flange 230 can extend around the entire periphery of the top edge 225 of the container 105 or a portion thereof. An example of the flange 230 can have a width, W2, of about ½ inches. As described below, the flange could include a hinge and/or have a width configured to stiffen sidewalls 210.

An example of the container 105 can be dimensioned to accommodate a foodstuff 130, such as a slice of bread, a bun, vegetables, etc. For example, the container 105 can have a width, W1, of about 4-6 inches, and a height, H1, of about 4-6 inches. The size can be different to accommodate foodstuffs 130 of different sizes.

The container 105 can be formed from a metal material such as stainless steel, aluminum, another metal, and/or a combination of metals. The material can have a thickness of 1/16 inches. An example of the container 105 can be formed from a uniform sheet of material via, for example, a stamping operation.

It should be noted that the various aspects of the container 105 described above can be different. For example, the container 105 can have a different shape, such as a generally cylindrical shape. The container 105 can be formed from any material suited for cooking such as copper, iron, a ceramic material, etc. The various edges can be chamfered. Other modifications can be made.

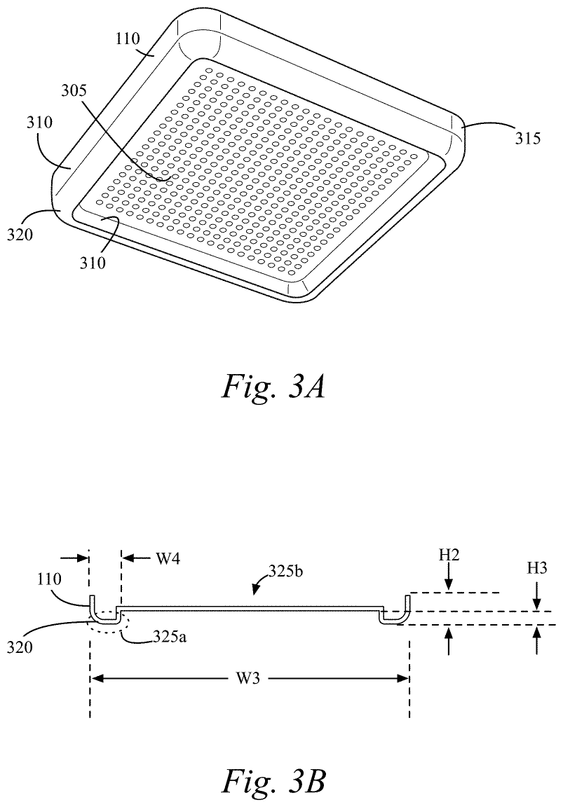

FIG. 3A illustrates a bottom perspective view of an example of the cooking surface 110. FIG. 3B illustrates a cross-sectional view of the cooking surface 110. An example of the cooking surface 110 can include a bottom surface 305 having a generally square shape and four generally planar sidewalls 310 that extend from edges 320 of the bottom surface 305. In some examples, the edges 315 between each of the sidewalls 310 and the edges 320 between the sidewalls 310 and the bottom surface 305 can have a radius of about ½ inch.

The width of the cooking surface 110 can be configured to be a margin smaller than the interior width of the container 105, as illustrated in FIG. 1B. For example, the cooking surface 110 can have a width, W3, of about 4-6 inches. The height, H3, of the cooking surface 110 can be configured to provide sufficient friction between the cooking surface 110 and the container 105 to secure the cooking surface 110 within the container 105. For example, the cooking surface 110 can have a height, H2, of about ½ inch.

In some examples, the width of the cooking surface 110 is configured so that the cooking surface 110 is held within the container 105 via resilient forces produced between the sidewalls 310 of the cooking surfaces 110 and the sidewalls 210 of the container 105. In this regard, in some examples, the cooking surface 110 can be provided with a feature (not shown) that facilitates removing the support surface from the container 105. For example, an opening can be provided in the cooking surface 110 into which a hook (not shown) can be arranged. The hook can be used to pull the cooking surface 110 out of the container 105, which can facilitate removal of the block 115 that is arranged below the cooking surface 110.

The bottom surface 305 of the cooking surface 110 can be perforated. The perforations are configured to allow steam to move through the cooking surface 110 and to prevent particles (e.g., food particles) from falling through the cooking surface 110 onto the block 115. For example, the perforations can have diameters of about a few thousandths of an inch and can be spaced apart from one other by, for example, 0.25 inches. The perforations can be uniformly arranged on the bottom surface 305 or can be concentrated in different areas of the bottom surface 305, such as around the edges, in the center, etc. The perforations can be distributed to maximize steam transfer through the cooking surface.

An example of the bottom surface 305 can be configured to provide a gap between the block 115 and cooking surface 110. For example, the bottom surface 305 can define an edge region 325a and a recessed region 325b. The edge region 325a can extend around the periphery of the bottom surface 305 and can have a width, W4, of about hundredths of an inch. The recessed region 325b can be recessed from the bottom-most extent of edge region 325a by a distance, H3, of about hundredths of an inch. When assembled, the edge region 325a may rest on the block 115, as illustrated in FIG. 1B. The region 325b (i.e., gap) between the top surface of the block 115 and the bottom surface 305 of the cooking surface 110 facilitates uniform distribution of steam dissipated by the block 115 to the perforations defined in the bottom surface 305.

The cooking surface 110 can be formed from a metal material suited for open-flame cooking, such as stainless steel. The material can have a thickness in the range of 1/16 to ¼ inches. An example of the cooking surface 110 can be formed from a uniform sheet of material via, for example, a stamping operation.

It should be noted that the various aspects of the cooking surface 110 described above can be different. For example, the cooking surface 110 can have a different shape, such as a generally cylindrical shape configured to fit within a container having a generally cylindrical shape. The cooking surface 110 can be formed from any material suited for open-flame cooking such as copper, iron, a ceramic material, etc. The various edges can be chamfered. Other modifications can be made.

As noted above, the block 115 can be formed from a porous ceramic material. The porous ceramic material can include small holes throughout, sized large enough to receive water while providing sufficient capillary pressure therein to retain the water when the water is in a liquid state. An example of the block 115 can have a shape that complements the interior of the lower chamber 312a of the container 105 (e.g., rounded edges or square edges as the case may be). For example, the block 115 can have a generally square cross-section that is a margin smaller (e.g., 1% smaller) than the interior extents of the container 105. The height of the block 115 can be configured to generally match the distance between the bottom surface 205 of the container 105 and the bottom-most extent of the edge region of the cooking surface 110 so that the block 115 fits securely between in the lower chamber 312a of the container 105. An example of the block 115 can have a height of between ¾ to 1.5 inches to facilitate relatively unimpeded insertion into the lower chamber 312a of the container 105.

In some examples, a single block 115 can be sized to occupy that lower chamber 312a. In other examples, multiple smaller blocks 115 (e.g., four blocks) can be arranged, for example, side-by-side within the lower chamber 312a. Additionally, or alternatively, ceramic plates formed from the porous ceramic material can be stacked to occupy the lower chamber 312a. The number of ceramic plates or smaller blocks used can depend on the amount of steaming to be performed. For example, a single ceramic plate or block can be used to steam a small slice of bread. Additional ceramic plates or blocks can be used to steam multiple slices of bread.

The block 115 is configured to absorb and retain water when the water is in a liquid state and to release the water in the form of steam when heated. When heated, steam from the block 115 passes into the upper chamber of the container 105 via the openings arranged in the cover 120 to distribute the steam to the upper chamber 312b of the container 105. The block 115 is further configured to retain water regardless of the orientation of the block 115. For example, the block 115 can retain water (i.e., not allow seepage) when the steaming device 100 is turned upside down. This can facilitate turning the steaming device 100 upside down over an open flame to char a foodstuff 130 disposed therein. It should be noted that when turned upside down, the cooking surface 110 is configured to remain in position so that the block 115 does not fall out of the steaming device 100.

An example of the cover 120 can be releasably attached to the container 105. For example, the cover 120 can be releasably secured to the container 105 with clips. Another example of the cover 120 can be releasably secured to the container 105 with magnets. For example, one or more rare-earth magnets can be arranged around the top edge 225 of the container to magnetically secure the cover 120 to the container 105. In another example, a hinge 122a can couple the cover 120 to the flange 230 of the container 105. A latch 122b can be arranged on the cover 120 or the container 105 to lock the cover 120 to the container 105.

When attached, the cover 120 can secure a foodstuff 130 within the steaming device 100. For example, the cover 120 can prevent a foodstuff 130 from falling out of the steaming device 100 when the steaming device 100 is turned upside down over an open flame. Turning the steaming device 100 upside down over an open flame can facilitate charring foodstuffs 130 contained therein.

An example of the cover 120 can be vented to allow steam to escape from the steaming device 100. For example, the cover 120 can correspond to a cage, such as a wire mesh. The space between wires of the mesh can be, for example, 1 inch apart. Another example of the cover 120 can correspond to a uniform sheet of material with perforations defined therethrough that facilitate the release of steam. In some examples, the size of the perforations can be configured to control the rate at which steam is released from the steaming device 100. For example, the openings may be reduced to increase the concentration of steam within the steaming device 100.

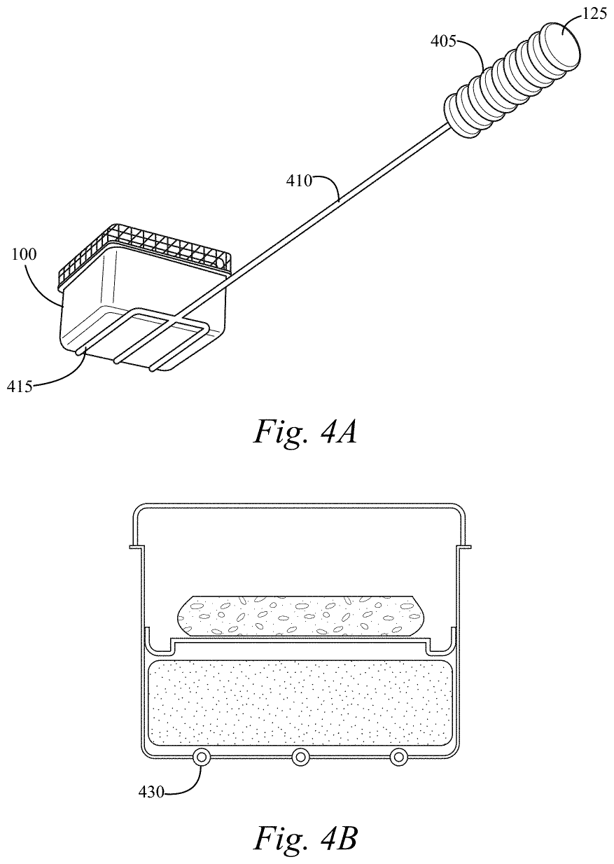

FIG. 4A illustrates an example of a handle 125 that can facilitate placing the steaming device 100 over a flame. The handle 125 can be configured to be arranged below the container 105 to facilitate supporting the steaming device 100 over a flame. The handle 125 can include a grip 405, an elongated member 410, and a group of prongs 415. The grip 405 can be coupled to a first end of the elongated member 420. The prongs 415 can extend from the second/opposite end of the elongated member 410. The grip 405 can be formed of a material having suitable insulative properties, such as wood, plastic, etc. The elongated member 410 and the prongs 415 can be formed from a durable material such as a metal material. The dimensions of the elongated member 410, prongs 415, and grip 405 can be configured to facilitate supporting the steaming device 100 during operation (e.g., with a foodstuff 130 therein and a fully saturated block 115). For example, the elongated member can have a diameter of about ¼ inches and can have a length of about 24-36 inches.

In some examples, the prongs 415 of the handle 125 can be fixed to the bottom surface 205 of the container 105. For example, the prongs 415 can be spot-welded to the bottom surface 205. In this regard, the prongs 415 can be fixed within the grooves 207 defined in the bottom surface 205 of the container 105. In these examples, the grooves 207 and the prongs 415 can cooperate to facilitate support of the steaming device 100 when the steaming device 100 is turned upside down.

The aspects of the steaming device 100 described above can be modified in various ways. For example, FIG. 4B illustrates an example of a steaming device 100 having enclosed channels 430 arranged on the bottom surface 205 of the container 105. The enclosed channels 430 can be configured to receive the prongs 415 of the handle 125 to facilitate placement of the steaming device 100 over a fire. The prongs 415 can be retracted from the enclosed channels 430 afterward. In this regard, some examples of the prongs 415 have a tip that facilitates using the handle 125 as a skewer for toasting bread or the like independent of the steaming device 100.

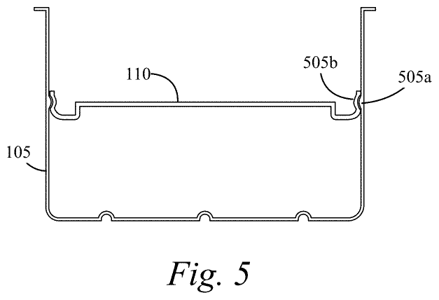

FIG. 5 illustrates an example of features that can be included in the cooking surface 110 and/or the container 105 to facilitate releasably securing the cooking surface 110 at a particular position within the container 105. For example, the container 105 can include one or more protrusions 505a on the sidewall(s) 210 that interlock with one or more complementary recesses 505b on the sidewall(s) 310 of the cooking surface 110. The feature or features can be arranged midway between the top edge 225 and the bottom edge of the sidewall 210 of the container 105 so that the cooking surface 110 divides the space within the container 105 equally between the lower chamber 312a and the upper chamber 312b.

In some examples, the container 105 can define such features at various positions along the sidewall 310 to facilitate insertion of the cooking surface at different positions within the container 105. This can facilitate the use of blocks 115 having different sizes that can store different amounts of water.

In yet other examples, an insulated holder can be provided table-side and the steaming device 100 can be placed on the holder after having been heated. Diners can access the steaming device on-demand to steam foodstuffs as needed (e.g., bread rolls that are brought to the table).

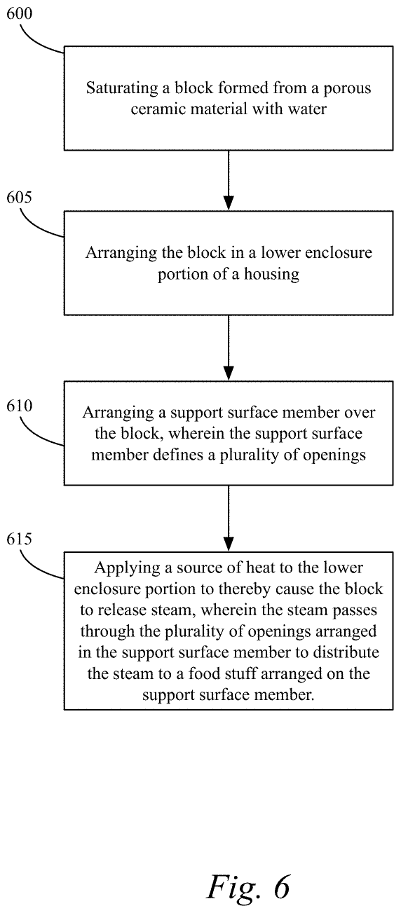

FIG. 6 illustrates examples of operations performed in a method for steaming a foodstuff 130. Operation 600 can involve saturating a block 115 formed from a porous ceramic material with water.

Operation 605 can involve arranging the block 115 in a container 105.

Operation 610 can involve arranging a cooking surface 110 over the block 115, wherein the cooking surface 110 can define a plurality of openings.

Operation 615 can involve applying a source of heat to the container 105 to thereby cause water stored in the block 115 to be released in the form of steam. The steam can then pass through the plurality of openings arranged in the cooking surface 110 and be distributed to a foodstuff 130 arranged on the cooking surface 110.

Some examples of the method can involve releasably attaching a cover 120 to the container 105. In these examples, the cover 120 secures the foodstuff 130 within the steaming device 100 and is vented to allow steam to escape from the steaming device 100.

In examples where the cover 120 is releasably attached to the container 105, the method can further involve hingedly attaching the cover 120 to a top edge 225 the container 105. The cover 120 can further include a latch that facilitates locking/latching the cover 120 to the container 105.

In some examples of the method, the cover 120 corresponds to a cage. For example, the cage can correspond to a wire mesh or grid.

Some examples of the method can involve supporting the container 105 with a handle 125.

In these examples, the handle 125 can include a rod, a grip coupled to a first end of the rod, and one or more prongs 415 coupled to a second end of the rod.

In these examples, the prongs 415 can be fixed to the bottom surface 205 of the container 105.

Some examples of the method can involve inserting the prongs into one or more enclosed channels 430 arranged on the bottom surface 205 of the container 105.

In these examples, an outside bottom surface 205 of the container 105 can define a plurality of enclosed channels 430 configured to receive a plurality of prongs 415 arranged at the end of the handle 125. The enclosed channels 430 and the prongs 415 can cooperate to facilitate support of the steaming device 100 when the steaming device 100 is turned upside down.

In some examples of the method, a sidewall 210 of the container 105 can include a protrusion 505a in a middle section configured to engage a recess 505b in a sidewall 310 of the cooking surface 110 to releasably secure the cooking surface 110 within the container 105.

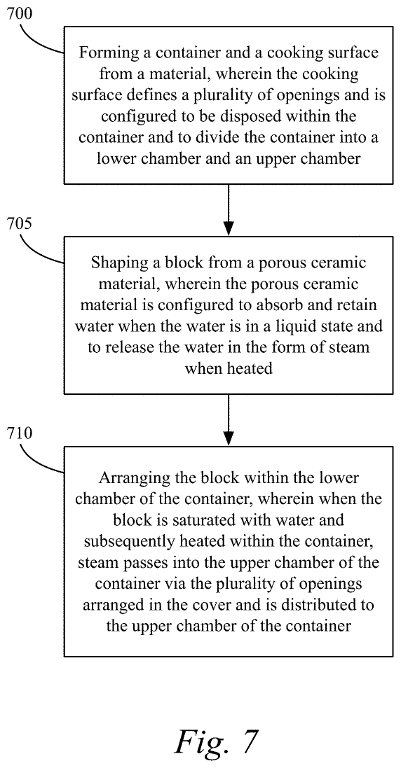

FIG. 7 illustrates examples of operations performed in a method for manufacturing a steaming device 100. Operation 700 can involve forming a container and a cooking surface from a material, wherein the cooking surface defines a plurality of openings and is configured to be disposed within the container and to divide the container into a lower chamber and an upper chamber.

Operation 705 can involve shaping a block from a porous ceramic material, wherein the porous ceramic material is configured to absorb and retain water when the water is in a liquid state and to release the water in the form of steam when heated.

Operation 710 can involve arranging the block within the lower chamber of the container, wherein when the block is saturated with water and subsequently heated within the container, steam passes into the upper chamber of the container via the plurality of openings arranged in the cover and is distributed to the upper chamber of the container.

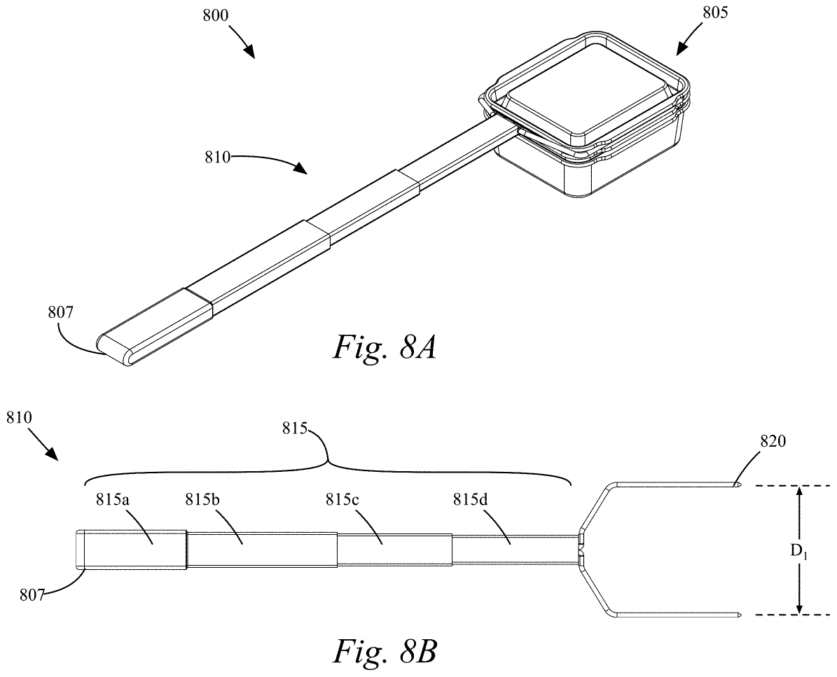

FIG. 8A illustrates a perspective view of another example of a steaming device 800. The steaming device 800 includes a cooking section 805 that comprises a group of nested chambers and a handle 810 that is coupled to and extends from the cooking section 805 and that facilitates handling the steaming device 800.

FIG. 8B illustrates a top view of the handle 810. An example of the handle 810 comprises an elongated member 815, a grip 807 coupled to a first end of the elongated member 815, and a pair of prongs 820 coupled to a second end of the elongated member 815. An example of the handle 810 is a telescoping handle. For instance, an example of the elongated member 815 comprises a group of segments 815a-815d (e.g., four segments) configured to slide past one another to shorten or lengthen the elongated member 815 of the handle 810. Examples of the segments 815a-815d have rectangular cross-sections that are between two and three inches long. The segmentation of the elongated member 815 facilitates collapsing the handle 810 to a shortened length of about three to four inches and expanding the handle 810 to about twelve to sixteen inches. Other examples of the elongated member 815 comprise a different number of segments and/or segments having different shaped cross-sections such as a circular-shaped cross-section, oval cross-section, etc.

Examples of the prongs 820 are configured to be inserted below one or more pairs of flanges of the cooking section 805 that are described below. In this regard, in an example, the distance, D1, between the prongs 820 is about 5.6 inches and is selected to facilitate lifting different components of the cooking section 805 of the steaming device 800.

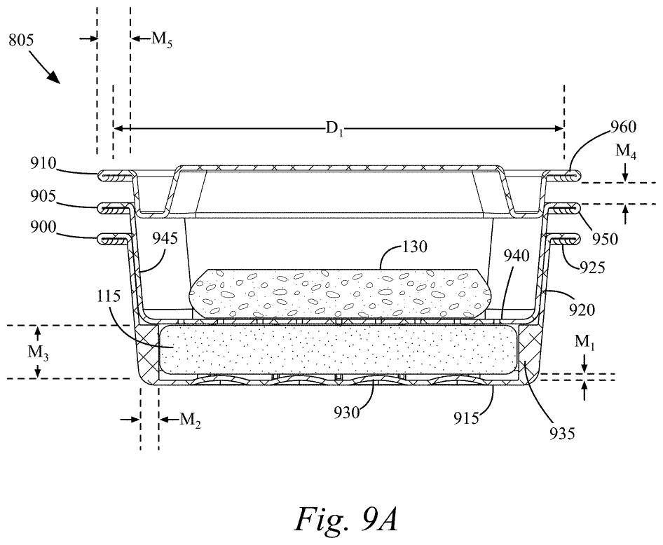

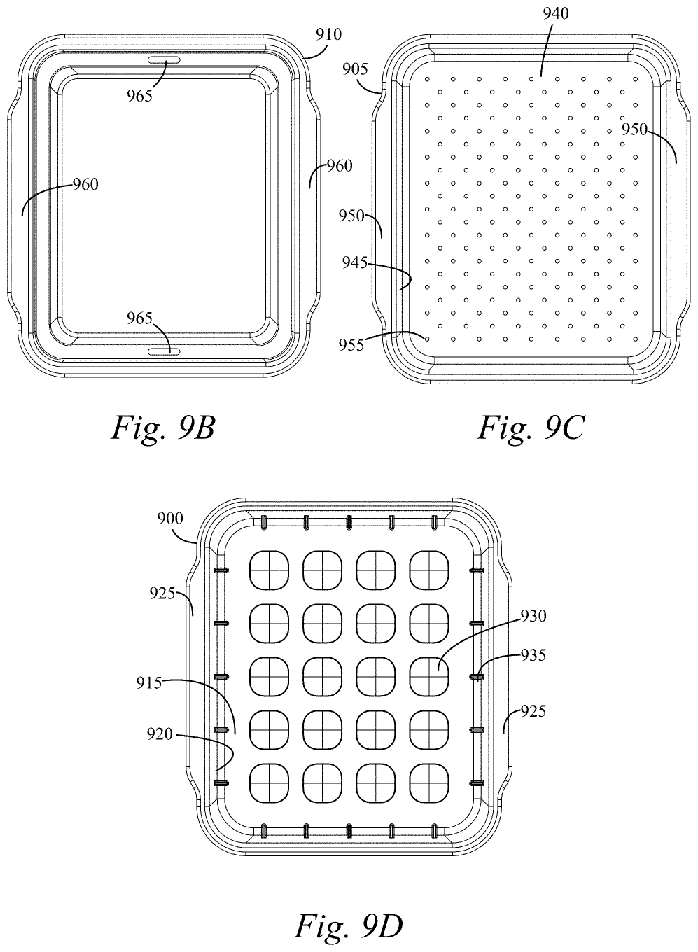

FIG. 9A illustrates a cross-section of the cooking section 805 of the steaming device 800. The cooking section 805 includes a lower chamber 900, an upper chamber 905, and a cover 910. Illustrated within the cooking section 805 are a block 115 and a foodstuff 130, as described above. FIGS. 9B-9D illustrate top views of the cover 910, the upper chamber 905, and the lower chamber 900, respectively. As illustrated in the figures, the upper chamber 905 is configured to nest within the lower chamber 900 to an extent, and the cover 910 is configured to nest within the upper chamber 905 to an extent.

The lower chamber 900 includes a bottom surface 915 having a generally square or somewhat rectangular shape and four generally planar sidewalls 920 that extend upwardly from the periphery of the bottom surface 915. In some examples, the sidewalls 920 are tapered and form an angle of about 95 degrees with the bottom surface 915. An example of the lower chamber 900 defines a volume of about 5.7 inches wide by 6.7 inches long by 1.920 inches high. In some examples, edges between each of the sidewalls 920 and between the sidewalls 920 and the bottom surface 915 are rounded. Some examples of the lower chamber 900 define a pair of flanges 925 positioned on opposite sidewalls 920 at the opening of the lower chamber 900. The flanges 925 extend outwardly from the sidewalls 920 by a distance, M₅, of about 0.2 inches.

An example of the bottom surface 915 of the lower chamber 900 defines one or more raised bumps 930 or protrusions. Examples of the bumps 930 facilitate providing a gap, M₁, between the bottom surface of the block 115 and the inside bottom surface 915 of the lower chamber 900 of about 0.06 inches. As shown in FIG. 9B, examples of the bumps 930 are arranged in a grid-like pattern and are evenly distributed across the bottom surface 915 of the lower chamber 900 (e.g., four-by-five grid of bumps 930).

Examples of the sidewalls 920 of the lower chamber 900 define one or more ribs 935 that extend inwardly by an extent, M₂ (e.g., 0.25 inches), towards the center of the lower chamber 900. In an example, the height of the ribs 935, M₃, from the bottom surface 915 of the lower chamber 900 towards the lower chamber opening is about 0.7 inches and may be selected to match the thickness of the block 115. The ribs 935 facilitate providing a gap, M₂, between the sidewalls 920 of the lower chamber 900 and sides of the block 115. In some examples, the upper chamber 905 rests on the ribs 935 when inserted into the lower chamber 900. In this regard, the ribs 935 limit the extent by which the upper chamber 905 nests within the lower chamber 900. As shown in FIG. 9B, examples of the ribs 935 are evenly spaced along the sidewalls 920 of the lower chamber 900 (e.g., five evenly spaced ribs per side).

An example of the upper chamber 905 is configured to receive a foodstuff 130 (e.g., a slice of bread). The upper chamber 905 includes a bottom surface 940 or cooking surface having a generally square or somewhat rectangular shape and four generally planar sidewalls 945 that extend upwardly from the periphery of the bottom surface 940 of the upper chamber 905. In some examples, the sidewalls 945 are tapered and form an angle of about 95 degrees with the bottom surface 940. An example of the upper chamber 905 defines a volume of about 5.7 inches wide by 6.7 inches long by 1.5 inches high. In some examples, edges between each of the sidewalls 945 and between the sidewalls 945 and the bottom surface 940 are rounded. Some examples of the upper chamber 905 define a pair of flanges 950 positioned on opposite sidewalls 945 at the opening of the upper chamber 905. The flanges 950 extend outwardly from the sidewalls 945 by a distance, M₅, of about 0.2 inches.

As shown in FIG. 9C, an example of the bottom surface 940 of the upper chamber 905 is perforated to facilitate egress of steam from the lower chamber 900. Examples of the perforations 955 are evenly distributed across the bottom surface 940 of the upper chamber 905.

An example of the cover 910 is configured to enclose the foodstuff 130 within the upper chamber 905. The cover 910 has a generally square shape. An example of the cover 910 defines an area that is about 5.7 inches wide by 6.7 inches long. Some examples of the cover 910 define a pair of flanges 960 positioned on opposite sides of the cover 910. Examples of the flanges 960 extend outwardly from the sides of the cover 910 by a distance, M₅, of about 0.2 inches.

As shown in FIG. 9B, an example of the cover 910 defines a pair of openings 965 to facilitate the release of steam from of the enclosed space between the cover 910 and the upper chamber 905. Some examples of the cover 910 can correspond to a cage (e.g., wire mesh cage or grid cage). While the cover 910 is illustrated as nesting within the upper chamber 905, in a different example, the cover 910 can be hingedly coupled to the flange 950 of the upper chamber 905.

As noted above, examples of the cover 910, the upper chamber 905, and the lower chamber 900 define flanges (925, 950, 960) that extend around their respective peripheries. In an example, the extent to which the cover 910, the upper chamber 905, and the lower chamber 900 nest within one another provides a gap having a height, M₄, of about 0.2 inches between adjacent flanges. In an example, the height, M₄, is selected to facilitate the insertion of the prongs 820 of the handle. For instance, in an example, the prongs 820 have a diameter that is a margin smaller than the gap between adjacent flanges.

In operation, the prongs 820 are inserted below the flanges 925 of the lower chamber 900 to facilitate placing the cooking section 805 over a flame. The prongs 820 are inserted between the flange 960 of the cover 910 and the flange 950 of the upper chamber 905 to facilitate lifting the cover 910 off of the upper chamber 905. Likewise, the prongs 820 are inserted between the flange 950 of the upper chamber 905 and the flange 925 of the lower chamber 900 to facilitate lifting the upper chamber 905 off of the lower chamber 900.

It will be understood that while various dimensions are noted in the present disclosure, other specific dimensions and/or dimension ranges are possible and contemplated. For example, it will be understood that steaming device 800 could be sized or dimensioned to accommodate various sizes and quantities of foodstuffs. For example, some embodiments of steaming device 800 could be sized to heat medium or large foodstuffs (e.g., several ears of corn), while other embodiments may be sized to heat small amounts of foodstuffs (e.g., individual vegetable servings, etc.).

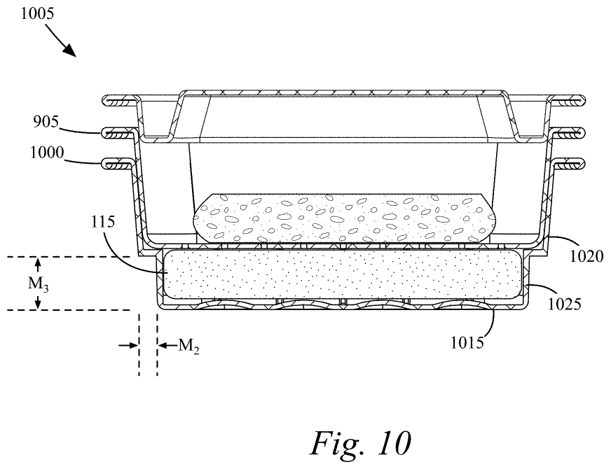

FIG. 10 illustrates a cross-section of an alternative cooking section 1005 of the steaming device 800. The cooking section 1005 shares various elements with the cooking section 805 described above and shown in FIG. 9A. A description of these elements is not repeated for the sake of brevity.

The primary differences between the cooking section 1005 of FIG. 10 and the cooking section 805 shown in FIG. 9A reside in the structure of the lower chamber. In the lower chamber 1000 of FIG. 10, the sidewalls 1020 define a stepped region 1025 that extends inwardly by an extent, M₂ (e.g., 0.25 inches), towards the center of the lower chamber 1000. In an example, the height of the stepped region 1025, M₃, from the bottom surface 1015 of the lower chamber 1000 towards the lower chamber opening is about 0.7 inches and may be selected to match the thickness of the block 115. In some examples, the upper chamber 905 rests on the stepped region 1025 when inserted into the lower chamber 1000. In this regard, the stepped region 1025 limits the extent by which the upper chamber 905 nests within the lower chamber 1000. This configuration also helps prevent steam from escaping along the sides of the upper chamber 904, and instead concentrates the release of steam through the perforations in the bottom surface 940 of the upper chamber 905. That is, the step region is configured to support the upper chamber and form a seal with the upper chamber to concentrate steam from the block through the perforations in the upper chamber.

Other examples of steaming devices are elucidated by the examples set forth below. For instance, an example of a steaming device comprises a container; a cooking surface disposed within the container and that divides the container into a lower chamber, and an upper chamber configured to receive a foodstuff. The cooking surface defines a plurality of openings. The steaming device further comprises a block formed from a porous ceramic material disposed within the lower chamber of the container. The block is configured to absorb and retain water when the water is in a liquid state and to release the water as steam when heated. The steam passes into the upper chamber of the container via the plurality of openings arranged in the cooking surface to distribute the steam to the upper chamber of the container to thereby steam the foodstuff.

An example of the steaming device further comprises a cover that is releasably attached to the container. When attached, the cover secures the foodstuff within the cover. The cover is vented to allow steam to escape from the steaming device. An example of this steaming device further comprises a hinge arranged at a top edge of the container to hingedly couple the cover to the container. An example of the cover corresponds to a cage.

An example of the steaming device further comprises a handle configured to support the container, and that facilitates placing the steaming device over a flame. An example of the handle comprises a rod, a grip coupled to a first end of the rod, and one or more prongs coupled to a second end of the rod. Examples of the prongs are fixed to a bottom surface of the container. An example of this steaming device further comprises one or more enclosed channels arranged on a bottom surface of the container. The enclosed channels are configured to receive the one or more prongs of the handle. In an example, the outside bottom surface of the container defines a plurality of grooves configured to receive the one or more prongs of the handle. The grooves and the one or more prongs cooperate to facilitate support of the steaming device when the steaming device is turned upside down.

In an example of the steaming device, the container further comprises a protrusion in a middle section configured to engage a recess in a sidewall of the cooking surface to releasably secure the cooking surface within the container.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A steaming device comprising:
a first chamber comprising a surface and sidewalls extending from the surface;
a second chamber that comprises a cooking surface and sidewalls extending from the cooking surface and that is configured to receive a foodstuff, wherein the cooking surface defines a plurality of openings; and
a block formed from a porous ceramic material disposed between the surface of the first chamber and the cooking surface of the second chamber, wherein the block is configured to absorb and retain water when the water is in a liquid state and to release the water as steam when heated, wherein the steam passes into the second chamber via the plurality of openings arranged in the cooking surface to distribute the steam to the second chamber to thereby steam the foodstuff.

2. The steaming device according to claim 1, wherein the second chamber comprises sidewalls that extend from the cooking surface, wherein the second chamber is configured to nest within the first chamber to an extent.

3. The steaming device according to claim 1, wherein the first chamber comprises a plurality of ribs positioned on the sidewalls of the first chamber, wherein a width of the ribs is selected to provide a gap of about 0.25 inches between sides of the block and the sidewalls of the first chamber, and a height of the ribs is selected to limit an extent by which the second chamber nests within the first chamber.

4. The steaming device according to claim 1, wherein the sidewalls of the first chamber define a step region that extends inward toward a center of the first chamber by an extent, wherein the step region is configured to support the second chamber and form a seal with the second chamber to concentrate steam from the block through the plurality of openings in the second chamber.

5. The steaming device according to claim 1, further comprising a cover configured to enclose the foodstuff within the second chamber, wherein the cover is vented to allow steam to escape from the steaming device.

6. The steaming device according to claim 4, wherein the second chamber comprises a flange that extends around a periphery of an opening of the second chamber, wherein the cover is hingedly coupled the flange of the second chamber.

7. The steaming device according to claim 1, further comprising a handle configured to support the steaming device, and that facilitates placing the steaming device over a flame.

8. The steaming device according to claim 7, wherein the handle comprises:
an elongated member;
a grip coupled to a first end of the elongated member; and
a pair of prongs coupled to a second end of the elongated member.

9. The steaming device according to claim 8, wherein the elongated member is a telescoping elongate member.

10. The steaming device according to claim 8, wherein the second chamber comprise a flange that extends around a periphery of an opening of the second chamber, wherein a spacing between the pair of prongs is selected to facilitate inserting the pair of prongs below the flange to facilitate separation of the second chamber from the first chamber.

11. The steaming device according to claim 1, wherein the first chamber comprises a plurality of bumps or protrusions on the surface of the first chamber that are sized to provide a gap of about 0.06 inches between a surface of the block and the surface of the first chamber.

12. A method for steaming a foodstuff comprising:
saturating a block formed from a porous ceramic material with water;
inserting the block within a first chamber that comprises a surface and sidewalls extending from the surface;
positioning a second chamber on the first chamber, wherein the second chamber comprises a cooking surface and sidewalls extending from the cooking surface and is configured to receive a foodstuff, wherein the cooking surface defines a plurality of openings; and
applying a source of heat to the first chamber to thereby cause the block to release steam, wherein the steam passes through the plurality of openings arranged in the cooking surface to distribute the steam to the second chamber.

13. The method according to claim 12, further comprising applying a cover over the second chamber, wherein when applied, the cover secures the foodstuff within the second chamber, and wherein the cover is vented to allow steam to escape from the second chamber.

14. The method according to claim 13, wherein the cover is hingedly attached to a top edge of the second chamber.

15. The method according to claim 13, wherein the cover corresponds to a cage.

16. The method according to claim 12, further comprising supporting the first chamber with a handle.

17. The method according to claim 16, wherein the handle comprises:
an elongated member;
a grip coupled to a first end of the elongated member; and
a pair of prongs coupled to a second end of the elongated member.

18. The method according to claim 17, wherein the elongated member is a telescoping elongate member.

19. The method according to claim 17, wherein supporting the first chamber further comprises inserting the pair of prongs below a pair of flanges of the first chamber to facilitate supporting of the second chamber.

20. A method for manufacturing a steaming device comprising:
forming a container and a cooking surface from a material, wherein the cooking surface defines a plurality of openings and is configured to be disposed within the container and to divide the container into a lower chamber and an upper chamber;
shaping a block from a porous ceramic material, wherein the porous ceramic material is configured to absorb and retain water when the water is in a liquid state and to release the water as steam when heated; and
arranging the block within the lower chamber of the container, wherein when the block is saturated with water and subsequently heated within the container, steam passes into the upper chamber of the container via the plurality of openings arranged in the cooking surface and is distributed to the upper chamber of the container.
